(19) United States
(12) Patent Application Publication
(10) Pub. No.: US 2011/0089169 A1
(43) Pub. Date: Apr. 21, 2011

(54) A WAVE CHOKE SYSTEM FOR A MICROWAVE OVEN DOOR

(75) Inventors: Arnd Hofmann, Lulsfeld (DE); Abdel-Ilah Zbat, Wurzburg (DE)

(73) Assignee: Electrolux Home Products Corporation N.V.

(21) Appl. No.: 12/675,901

(22) PCT Filed: Jul. 30, 2008
(86) PCT No.: PCT/EP08/06275

§ 371 Date: Oct. 15, 2010

(30) Foreign Application Priority Data
Sep. 3, 2007 (EP) 07017206.9

(51) Int. Cl. H05B 6/76

(52) U.S. Cl. 219/741

(57) ABSTRACT

The present invention relates to a wave choke system for an oven door of a microwave oven. The wave choke system comprises a wave trap (10) on at least one circumferential side of the oven door. The wave trap (10) is provided as an open channel made of conductive material and extends along the circumferential side of the oven door or on a portion of said circumferential side. According to the present invention the wave trap (10) is subdivided into a plurality of open cells (24) on at least one circumferential side of the oven door by separating elements (22), so that the open cells (24) are arranged serially along the longitudinal axis of the wave trap (10), wherein said separating elements (22) are formed as a sheet made of a conductive material. Further, the present invention relates to a corresponding oven door and a corresponding microwave oven.

The present invention relates to a wave choke system for an oven door of a microwave oven. Further, the present invention relates to an oven door of a microwave oven. Additionally, the present invention relates to a microwave oven.

A microwave oven generates strong electromagnetic fields in order to heat the food stuff. Said electromagnetic fields are potential threat to the health of the operator, if the electromagnetic fields or parts of them leave the cavity. The door of the microwave oven is critical. In particular, the microwaves may leave the cavity through the gap between the door and the cavity.

The gap between the door and the cavity is sealed with respect to microwaves by integrating wave chokes into the door of the microwave oven. Said wave chokes provide a small band stop by a cascaded λ/4-transformation. However, mechanical tolerances of the oven cavity frame and the frame of the oven door can evoke local areas of an increased leakage.

It is an object of the present invention to provide a wave choke system for a microwave oven door, which is more robust against mechanical tolerances of the oven cavity walls and the oven door frame.

This object is achieved by the wave choke system according to claim 1.

According to the present invention the wave trap is subdivided into a plurality of open cells by separating elements on at least one circumferential side of the oven door, so that the open cells are arranged serially along the longitudinal axis of the wave trap, wherein said separating elements are formed as a sheet made of a conductive material.

The main idea of the invention is the wave trap with the separating elements and the resulting open cells. The open cells are small cavities with one open side. The open cells allow that the deepness of the wave trap may be increased compared to the prior art. The greater deepness effect that the wave choke system is more robust against mechanical tolerances.

According to the preferred embodiment of the present invention the distance between two neighbouring separating elements is greater than the half of the effective wavelength inside the single open cell related to an operating frequency of the microwave oven. This guarantees the effect of the invention.

Preferably, the distances between neighbouring separating elements are equal. The equal distances between neighbouring separating elements allow a simple and an automatic manufacturing of the wave trap.

Alternatively, the distances between neighbouring separating elements may be are different. In general, it is not necessary, that the distances between neighbouring separating elements are uniform.

The separating element may be formed as a sheet made of conductive material, in particular of metal or a sheet made of dielectric material with metal coating. Alternatively, the separating element may be formed as a grid made of metal wires.

According to the preferred embodiment of the present invention the distances between the neighbouring separating elements are between 30 mm and 120 mm.

Preferably, the wave trap encloses completely the oven door along the circumferential direction.

The wave trap is made of metal or a dielectric material coated with metal.

Further, the wave trap has substantially a rectangular cross section, which may be bordered by an outer circumferential side, an inner circumferential side, an outer side and an inner side.

For example, the outer circumferential side, the inner circumferential side and the outer side form a U-shaped profile. Thus, the wave trap may be used as a door frame or a part of the door frame.

An open portion of the open channel may be arranged on the inner side of the wave trap. The inner side comprises a plurality of lamellae. Further, a gap is arranged between the lamellae and an inner edge of the outer side of the wave trap. Preferably, the gap has a width between 10 mm and 14 mm.

The separating elements may be rectangular sheets. Thus, the lamellae may fill a part of the cross section of the wave trap.

The open cells are at least partially filled with at least one dielectric material. Additionally or alternatively, the open cells are at least partially filled with air.

Further, the present invention relates to an oven door for a microwave oven comprising the wave choke system as described above.

At last, the present invention relates to a microwave oven comprising the wave choke system and/or the oven door as described above.

The novel and inventive features believed to be the characteristic of the present invention are set forth in the appended claims.

The invention will be described in further detail with reference to the drawing, in which

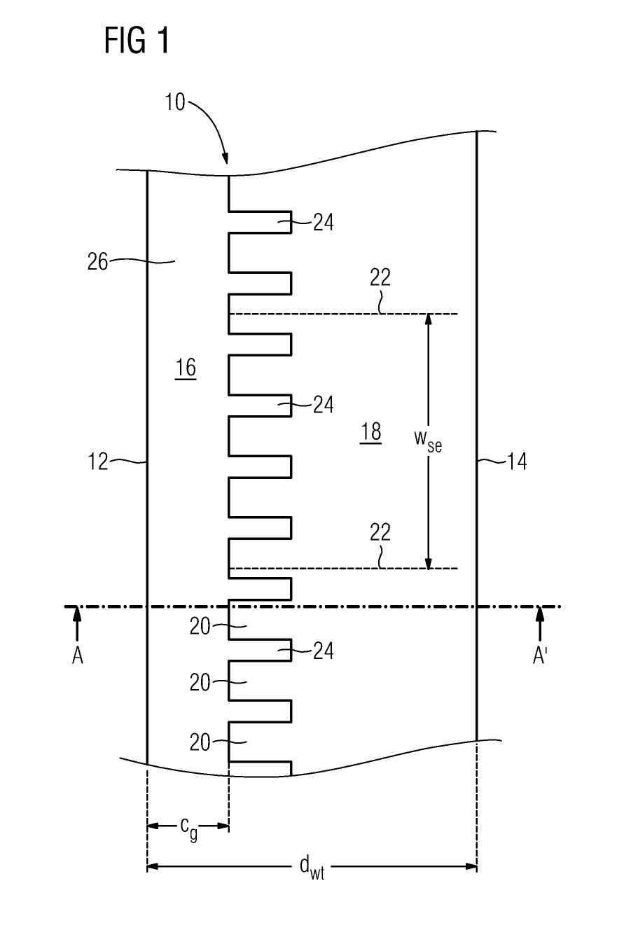

FIG. 1 illustrates a schematic partial view of a wave choke system for microwave oven door according to a preferred embodiment of the present invention, and

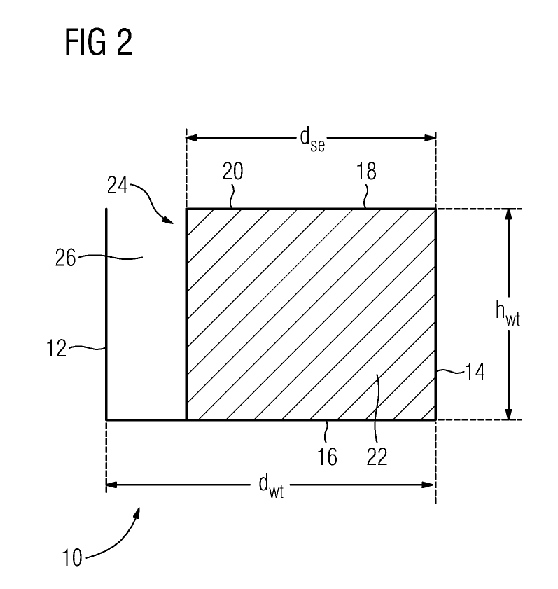

FIG. 2 illustrates a schematic sectional view of a part of the oven door with the wave choke system according to the preferred embodiment of the present invention.

FIG. 1 illustrates a schematic partial view of a wave choke system for a microwave oven door according to a preferred embodiment of the present invention. The wave choke system comprises a wave trap 10. The wave trap 10 is formed as a channel with a rectangular cross section. The wave trap 10 forms a frame or the part of the frame of an oven door of a microwave oven. Thus, the wave trap 10 forms the outer portion of the microwave oven door.

The wave trap 10 includes an outer circumferential side 12, an inner circumferential side 14, an outer side 16 and an inner side 18. The outer side 16 is a part of the outer side of the oven door. In the same way the inner side 18 is a part of the inner side of the oven door. The outer circumferential side 12 corresponds with a circumferential side of the oven door or with a part of said circumferential side. The inner circumferential side 14 encloses at least partially an inner portion of the oven door. Said inner portion may be a window, for example.

The inner side 18 comprises a plurality of lamellae 20. Said lamellae 20 extend into the direction of the outer circumferential side 12. The outer circumferential side 12, the inner circumferential side 14 and the inner side 16 form a U-shaped profile. Said U-shaped profile is substantially symmetric. The inner side 16 is smaller than the outer side 18. The inner edge of the inner side 18 joins the inner edge of the inner circumferential side 14, so that there is a gap between the inner edge of the outer circumferential side 12 and the outer edge of the inner circumferential side 14. In other words there is a gap 26 between the inner edge of the outer circumferential side 12 and the lamellae 20. In this example the width c_{g} width of the gap 26 is about between 10 mm and 14 mm. The gap 26 and the slots between the lamellae 20 define the open portion of the wave trap 10.

The wave trap 10 is subdivided into a plurality of open cells 24 by separating elements 22. The separating elements 22 are formed as rectangular sheets made of a conductive material. For example, the separating element 22 may be a metal sheet. Further, the separating element 22 may be a web made of metal wire. In this example the distance wₛₑ between two neighbouring separating elements 22 is about between 30 mm and 120 mm. The distance wₛₑ between two neighbouring separating elements 22 must be more than a half of the wavelength of the microwave.

The open cells 24 between the separating elements 22 allow that the deepness d_{wt} of the wave trap 10 is independent of the wavelength of the microwave. Thus, the deepness d_{wt} of the inventive wave trap 10 may be greater than the deepness of a wave trap according to the prior art. The greater deepness d_{wt} of the inventive wave trap 10 effects that the wave choke system is more robust against mechanical tolerances of the oven cavity wall. This results in a reduced leakage of the oven cavity.

FIG. 2 illustrates a sectional view of the inventive wave trap 10 along the line A-A′ in FIG. 1. The outer circumferential side 12, the inner circumferential side 14 and the outer side 16 form the U-shaped profile. In the preferred embodiment the outer edges of the separating elements 22 are flush with the edges of the lamellae 20. In general, the depth dₛₑ of the separating elements 22 is arbitrary. The height h_{wt} of the wave trap 10 corresponds with the height of the separating elements 22.

The space between two neighbouring separating elements 22 forms the open cell 24. Preferably, the distances wₛₑ between the neighbouring separating elements 22 are uniform. However, different distances wₛₑ between the neighbouring separating elements 22 are also possible.

The inner space of the wave trap 10 may be filled by air or an arbitrary dielectric material.

The wave choke system according to the present invention allows a reduced leakage and can be manufactured in a simple way.

Although illustrative embodiments of the present invention have been described herein with reference to the accompanying drawing, it is to be understood that the present invention is not limited to those precise embodiments and that various other changes and modifications may be affected therein by one skilled in the art without departing from the scope or spirit of the invention. All such changes and modifications are intended to be included within the scope of the invention as defined by the appended claims.

### LIST OF REFERENCE NUMERALS

10 wave trap
12 outer circumferential side
14 inner circumferential side
16 outer side
18 inner side
20 lamella
22 separating element
24 open cell
26 gap
c_{g} width of the gap
wₛₑ distance between separating element
d_{wt} deepness of the wave trap
dₛₑ deepness of the separating element
h_{wt} height of the wave trap

1. A wave choke system for an oven door of a microwave oven, wherein
said wave choke system comprises a wave trap (10) on at least one circumferential side of the oven door, which wave trap (10) is provided as an open channel made of conductive material and extends along the circumferential side of the oven door or on a portion of said circumferential side,
characterized in, that
the wave trap (10) is subdivided into a plurality of open cells (24) by separating elements (22) on at least one circumferential side of the oven door, so that the open cells (24) are arranged serially along the longitudinal axis of the wave trap (10), wherein said separating elements (22) are formed as a sheet made of conductive material.

2. The wave choke system according to claim 1,
characterized in, that
the distance (wₛₑ) between two neighbouring separating elements (22) is greater than the half of the effective wavelength inside the single open cell (24) related to an operating frequency of the microwave oven.

3. The wave choke system according to claim 1 or 2,
characterized in, that
the distances (wₛₑ) between neighbouring separating elements (22) are equal.

4. The wave choke system according to claim 1 or 2,
characterized in, that
the distances (wₛₑ) between neighbouring separating elements (22) are different.

5. The wave choke system according to any one of the preceding claims,
characterized in, that
the separating element (22) is formed as a sheet made of conductive material, in particular of metal or a sheet made of dielectric material with metal coating.

6. The wave choke system according to any one of the preceding claims,
characterized in, that
the separating element (22) is formed as a grid made of metal wires.

7. The wave choke system according to any one of the preceding claims,
characterized in, that
the distances (wₛₑ) between the neighbouring separating elements (22) are between 30 mm and 120 mm.

8. The wave choke system according to any one of the preceding claims,
characterized in, that
the wave trap (10) encloses completely the oven door along the circumferential direction of said oven door.

9. The wave choke system according to any one of the preceding claims,
characterized in, that
the wave trap (10) is made of metal.

10. The wave choke system according to any one of the claims 1 to 8,
characterized in, that
the wave trap (10) is made of a dielectric material coated with metal.

11. The wave choke system according to any one of the preceding claims,
characterized in, that
the wave trap (10) has substantially a rectangular cross section.

12. The wave choke system according to claim 11,
characterized in, that
the cross section of the wave trap (10) is bordered by an outer circumferential side (12), an inner circumferential side (14), an outer side (16) and an inner side (18).

13. The wave choke system according to claim 12,
characterized in, that
the outer circumferential side (12), the inner circumferential side (14) and the outer side (16) form a U-shaped profile.

14. The wave choke system according to claim 12 or 13,
characterized in, that
an open portion of the open channel is arranged on the inner side (20) of the wave trap (10).

15. The wave choke system according to any one of the claims 12 to 14,
characterized in, that
the inner side (18) comprises a plurality of lamellae (20).

16. The wave choke system according to claim 15,
characterized in, that
a gap (26) is arranged between the lamellae (20) and an inner edge of the outer side (12) of the wave trap (10).

17. The wave choke system according to claim 16,
characterized in, that
the gap (26) has a width (c_{g}) between 10 mm and 14 mm.

18. The wave choke system according to any one of the preceding claims,
characterized in, that
the separating elements (22) are rectangular sheets.

19. The wave choke system according to any one of the preceding claims,
characterized in, that
the open cells (24) are at least partially filled with at least one dielectric material.

20. The wave choke system according to any one of the preceding claims,
characterized in, that
the open cells (24) are at least partially filled with air.

21. An oven door for a microwave oven,
characterized in, that
the oven door comprises a wave choke system according to any one of the claims 1 to 18.

22. A microwave oven,
characterized in, that
the microwave oven comprises a wave choke system according to any one of the claims 1 to 18.

23. The microwave oven according to claim 20,
characterized in, that
the microwave oven comprises an oven door according to claim 18.
